(19) United States
(12) Patent Application Publication
(10) Pub. No.: US 2005/0162516 A1
(43) Pub. Date: Jul. 28, 2005

(54) Method and analysis tool for checking the functional suitability of video monitoring devices, as well as a measurement device for carrying out the method

(75) Inventors: Markus Loepfe, Feldmeilen (CH); Giuseppe Marbach, Hombrechtikon (CH); Kurt Muller, Mannedorf (CH); Dieter Wieser, Kusnacht (CH)

Correspondence Address: Maginot, Moore & Beck;Bank One Tower, Suite 3000, 111 Monument Circle, Indianapolis, IN, 46204, US

(73) Assignee: Siemens Schwiez AG, Zurich (CH)

(21) Appl. No.: 10/949,817

(22) Filed: Sep. 24, 2004

(30) Foreign Application Priority Data
Sep. 25, 2003 (EP) 03021600.6

(51) Int. Cl. H04N 17/00; H04N 17/02

(52) U.S. Cl. 348/156; 348/184; 348/187

(57) ABSTRACT

The functional suitability of video monitoring devices which have at least one camera (8) is checked by means of a measurement device which has a processor (4), and by means of an analysis tool (7) which can be implanted in the processor (4). In this case, the images which are supplied from the at least one camera (8) are analyzed for parameters which are characteristic of the respective function. The analysis tool (7) is formed essentially by software which comprises two modules (5, 6), with one module (5) being provided for the application-specific configuration of the software and containing significant parameters for the current or intended application. The other module (6) is provided for the analysis of the images which are supplied from the at least one camera (8), during which analysis the quality of the images is assessed with respect to the said parameters.

### DESCRIPTION

The invention relates to the checking of the functional suitability of video monitoring devices which have at least one camera. In this case, checking of the functional suitability means that a check is carried out to determine whether an installed video monitoring device on the one hand is operating satisfactorily and complies with the agreed specifications, and whether such a monitoring device, on the other hand, could be used for additional applications.

Video monitoring devices are widely used nowadays, and are used for many applications. In addition to devices which are used for protection against unauthorized entry, theft, robbery and raids in private and public buildings, and in public spaces, video monitoring devices are increasingly being used for road traffic, and in this case in particular for monitoring the traffic in tunnels, with the monitoring being carried out virtually exclusively by personnel seated in front of monitors.

While video cameras have already been used for years for traffic monitoring, trials have only recently been carried out to use video images to automatically detect certain traffic situations, for example the formation of jams, abandoned vehicles or accidents and other hazard situations, such as smoke or flame formation, in order to make it possible to initiate specific counter measures as quickly as possible. With regard to smoke and flame detection, reference is made to WO-A-02/054364 and EP Patent Application No. 03 015 846.3 from Siemens Building Technologies AG, which are hereby expressly included by reference.

Owing to the large number of already installed video devices for traffic monitoring, there is an increasing tendency to retrospectively convert such devices for further applications, such as smoke and/or flame detection, in which case the conversion process should be carried out as far as possible without disturbing the traffic flow. This applies in particular to tunnels because, in general, any work in a tunnel is associated with at least one lane being blocked.

For this reason, the tunnel operators wish to be able to convert existing video traffic monitoring installations retrospectively and as far as possible without any disturbance to carry out smoke and/or flame detection, and to have the capability to check the suitability of the offered systems, and to compare offered systems with one another. On the other hand, the manufacturers and providers of video, smoke and flame detection systems also have an interest in whether their system is suitable for that particular traffic installation.

A further wish, from both the manufacturers and the operators, is the provision of a test or measurement system for checking the functional suitability of an existing video monitoring device, for example in the course of maintenance work, or when false alarms occur, or the like.

The influence of physical characteristics on the functional suitability of a video smoke detection system in checks such as these should not be underestimated. For example, in the case of the smoke detection system which is described in the cited WO-A-02/054364, the smoke detection is carried out by investigation of the time profile of the brightness of the individual pixels or of groups of pixels in video images, with the pixel brightness being determined by means of an edge extraction process, in which each pixel is allocated an edge value. This is essentially a method based on contrast changes. As can easily be seen, contrast changes can presumably be detected significantly less well in a poorly illuminated tunnel or in a tunnel with dark walls, than in a bright and well illuminated tunnel.

The present invention relates to a method for checking the functional suitability of video monitoring devices which have at least one camera. The method according to the invention is intended to make it possible to check the functional suitability of an existing video monitoring device in as simple a manner as possible as well as objectively and reproducibly, without this leading to any adverse effect on the operation of this monitoring device.

According to the invention, this object is achieved in that the images the images supplied from the at least one camera are checked by means of a measurement device, which has a processor, and by means of an analysis tool, which can be implanted in the processor, for parameters which are characteristic of the respective function.

A first preferred embodiment of the method according to the invention is characterized in that the said analysis tool is formed essentially by software which comprises two modules, with one module being provided for the application-specific configuration of the software and containing significant parameters for the current application or for an intended application, and the other module being provided for the analysis of the images which are supplied from the at least one camera, during which analysis the quality of the images is assessed with respect to the said parameters.

A second preferred embodiment of the method according to the invention is characterized in that the said significant parameters are formed by at least one variable from the group comprising the number of edges in the image, the contrast in the image as an entity, the number of light or dark saturated pixels, and the color of the images, in that the quality of the parameters which characterize the respective image is assessed, and in that the result of this assessment is displayed.

A third preferred embodiment of the method according to the invention is characterized in that the result of the assessment of each parameter is displayed by means of a display band which runs in a bar, with the filling level of the bar representing a measure of the quality of the respective parameter.

The method according to the invention makes it possible to check an existing video monitoring device in a simple manner to determine whether it still complies with the stated requirements, in that the or one camera of this device is connected to the measurement device, the analysis tool is appropriately configured, and the result of the analysis is interpreted. It is then possible to see at a glance whether, for example, there are sufficient edges anyway in the images of a video monitoring device which is used for smoke detection, or whether the contrast is sufficient. However, it is also possible to assess at a glance whether a video monitoring device which is used, by way of example, for traffic monitoring would be suitable for smoke detection, by once again checking whether sufficient edges are present and the contrast is adequate. If this is not the case, then suitable measures for improvement of the quality of these parameters can be evaluated by, for example, improving the illumination in the tunnel and/or by painting its walls in light colors, and/or by applying suitable markings to the edge of the road.

The invention furthermore relates to an analysis tool for checking the images which are supplied from a camera of a video monitoring device for the functional suitability of the video monitoring device. The analysis tool according to the invention is characterized by a first module, which is referred to in the following text as a configuration module, for the application-specific configuration of the analysis tool, and by a second module, which is referred to in the following text as a diagnosis module, for the analysis of the images which are supplied from the at least one camera, with the configuration module containing parameters which are relevant for functional suitability, and with an assessment of the quality of the images with respect to the said parameters being carried out in the diagnosis module.

The invention furthermore relates to a measurement device for carrying out said method. The measurement device according to the invention is characterized by a laptop or by some other transportable computer with a keyboard for entering application-specific data, with a screen and with a processor in which the said analysis tool is implemented.

A first preferred embodiment of the measurement device according to the invention is characterized in that, in the ready to receive operating mode, a dialog box is displayed on the screen, which dialog box has an image field with the image to be evaluated, a display field for the result of the check, an information field for information about the mode and/or status of the current program, and a row of operating buttons. The display field for the result of the check preferably has a row of display bars for the individual parameters.

A second preferred embodiment of the measurement device according to the invention is characterized in that the image field optionally displays the current image from the at least one camera or an image, which is stored in the hard disk of the laptop, from a previously recorded image sequence.

The invention will be explained in more detail in the following text with reference to an exemplary embodiment and to the drawings, in which:

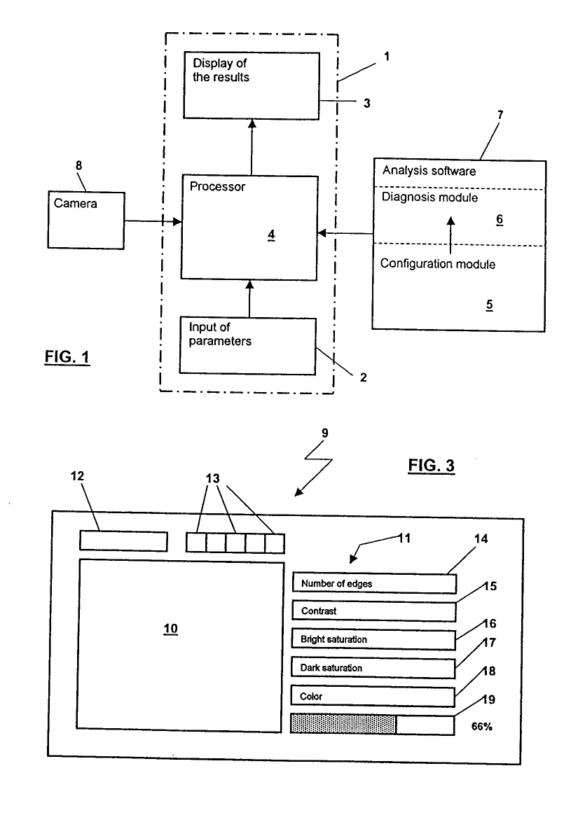

FIG. 1 shows a block diagram of a measurement device according to the invention,

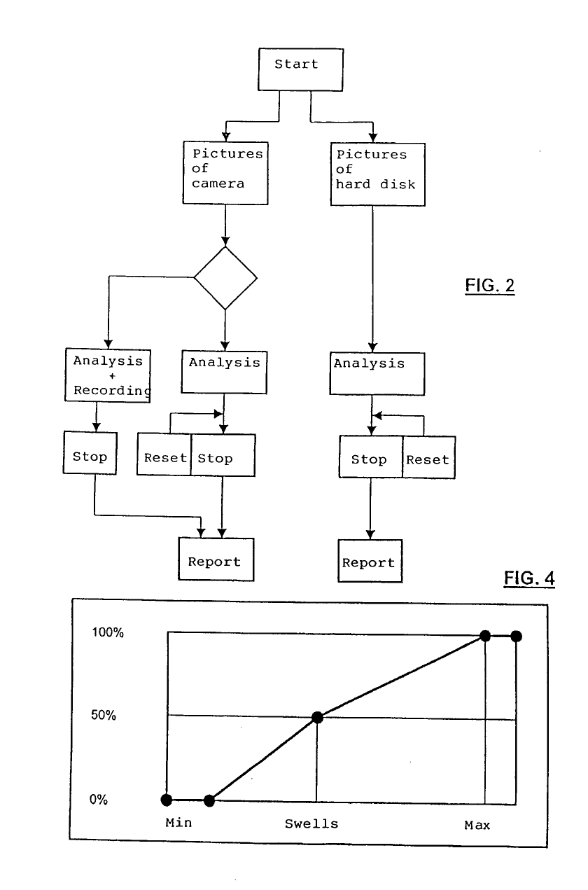

FIG. 2 shows a flowchart of a measuring process for the measurement device shown in FIG. 1,

FIG. 3 shows a detail of the measurement device shown in FIG. 1; and

FIG. 4 shows a diagram in order to explain the operation.

The illustrated measurement device has a computer 1, which is annotated with the reference symbol 1, for example a laptop or PC, with a keyboard 2 for entering parameters, a screen 3 for displaying results, a frame grabber (not illustrated) and a processor 4 in which analysis software 7 is implemented, comprising a configuration module 5 and a diagnosis module 6. The computer 1 has a connection for at least one camera 8 of a video monitoring device. The analysis software 7, which is stored on a data storage medium, for example on a CD, and which is installed in the computer 1 before initial use of the measurement device, is a tool for assessment whether the quality of the images of an existing video monitoring device is sufficient for smoke or flame detection or else for automatic monitoring of the traffic situation, such as jams, accidents or broken-down vehicles in a tunnel. The following description of the analysis software 7 in conjunction with smoke and flame detection should not be regarded as being restrictive. It is obvious to a person skilled in the art that the traffic situation mentioned can be described by suitable parameters, and that the quality of these parameters can be monitored.

The analysis software 7 may record on-line video images from the camera 8, may reproduce them on the screen 3, may analyze and store them, or may read stored image sequences from the hard disk, may reproduce them on the screen 3, and may analyze them. A report which includes the values of the investigated parameters is issued for each analysis.

FIG. 2 shows a flowchart of a measurement or analysis process such as this using the measurement device. Before the start of the measuring process, the required settings are made, in particular by setting the threshold values and the maximum and minimum values for the individual parameters. For smoke and flame detection, the parameters are as follows:

Number of edges in the image: If the contrast between one pixel and the adjacent pixels is greater than a predetermined threshold, then this pixel forms an image edge. The value of this parameter indicates whether there are sufficient edges in the images.

Contrast of the image as an entity: This relates to the standard deviation of the luminance, that is to say essentially to the visual impression. This is important because objects cannot be distinguished from the background if the dynamic range is narrow.

Bright and dark saturation: The number of pixels which are saturated black or white.

Color: An indication as to whether the images contain sufficient color information for the intended application.

Possible further parameters include the noise, the status of the camera (switched on/off), and the like.

A further setting relates to the definition of that part of the image from the camera 8 which is to be evaluated. This is set by means of a mask which, for example for smoke detection, is placed in the upper half or in the upper third of the camera image. The parameters which have been mentioned, the position of the mask and possibly further setting values can be set individually for each configuration (smoke, flame, traffic monitoring), and can be called up in the dialog box which is illustrated in FIG. 3.

As has already been mentioned, there are two operating modes for the analysis software 7. In one mode, which is illustrated in the left-hand branch in FIG. 2, the video images come from the camera 8 (FIG. 1), while in the second mode, which is illustrated in the right-hand branch in FIG. 2, the video images come as an image sequence from the hard disk of the computer 1. For video images from the camera, the frame grabber is used as a buffer store and for digitization. When the analysis software is started up, a selection is made as to whether the camera will be chosen as the image source, or whether an image sequence will be chosen from the hard disk. If images are chosen from the camera, pure analysis of the current images can be selected, with a report file, or analysis of the images including storage of the images on the hard disk with the report file. The latter variant is intended in particular for situations where the analysis is intended to be carried out over a lengthy time period of hours or even days, with images being stored periodically.

If the images come from the hard disk, an analysis is carried out with a report file. Both an image analysis and image storage on the hard disk can be stopped by pushing an appropriate function button. When a reset button is operated, during the analysis of the camera images, the image counter is set to zero and, during analysis of an image sequence from the hard disk, the analysis is started again at the frame number zero.

The report file can be printed out; each report contains a tabular report with the date, the identification of the camera or of the stored file, and with the values of the analyzed image parameters.

FIG. 3 shows a dialog box 9 which appears on the screen 3 as soon as the measurement device is ready for a measurement. The dialog box contains two display fields 10 and 11 for displaying the image currently being recorded by the camera 8 (display field 10) and/or the parameters for assessment of the image (display field 11). A title line 12 is provided above the display field 10, for information relating to the mode and/or status of the current program, or relating to the current configuration (smoke, flame, traffic monitoring), with a row of control buttons for controlling the analysis software 7 being provided alongside the title line 12, as shown in FIG. 2. A footer line (not shown) is provided underneath the display field 10, for further status and/or mode information.

The display field 11 contains a number of horizontal bars, which are arranged one above the other, or else vertical bars, which are arranged alongside one another, for displaying the parameters which are relevant for the selected configuration. When a tunnel is being monitored for the occurrence of smoke these would be, for example, the parameters “number of edges” (bar 14), “contrast” (bar 15), “bright saturation” (bar 16) and “dark saturation” (bar 17). The parameter “color” (bar 18) is not analyzed in this case. The representation of the parameters is illustrated in the bars on the basis of the lowermost bar 19, which has no associated parameter in the figure.

A colored display band is located in the bar, for qualitative assessment of the quality of the parameter emitted. If the display band extends to the center of the bar, which is the 50% value, this indicates that the relative parameter currently satisfies the requirements. A value of 0% at the left-hand end of the bar and a value of 100% at the right-hand end of the bar respectively indicate poor and very good. The length of the colored bar indicates a value averaged over time, for example, over 250 frames and, furthermore, there is also a vertical line on the bar, which indicates the value of that particular parameter for the individual image currently being dealt with. Finally, the value of the bar, that is to say the value averaged over time, is displayed numerically to the right of each bar.

When monitoring a tunnel for the occurrence of flames, the parameter “number of edges” in the bar 14 is not analyzed, and the parameter “color” in the bar 18 is evaluated and displayed for this purpose.

The diagram in FIG. 4 shows the transfer of the parameter values for the image in the display field 10 to the bars, with the abscissa denoting the parameter axis, and the ordinate the extent to which the bar is filled. First of all, the relevant parameter on the parameter axis is allocated minimum value “Min”, which is classified as being very poor, and then a value “Max”, which is classified as being very good, and a value “threshold”, which is regarded as being adequate. The value “Min” is then associated with the filling level 0%, the value “Max” with the filling level 100%, and the value “threshold” with the filling level 50%. The filling level of the bar increases linearly from 0% to 50% from “Min” to “threshold”, and linearly from 50% to 100% from “threshold” to “Max”. When the number of edges displayed in the bar 14 is 0%, then this does not in fact mean that no edges at all can be detected, but only that the minimum number of edges, corresponding to the value “Min” have been detected. This also applies in the same sense to the two percentage values 50% and 100%.

1-14. (canceled)

15. A method for checking the functional suitability of video monitoring devices which have at least one camera, characterized in that the images supplied from the at least one camera are checked by a measurement device, which has a processor, and by an analysis tool, which can be implanted in the processor, for parameters which are characteristic of the respective function.

16. The method as claimed in claim 15, characterized in that said analysis tool is formed essentially by software which comprises two modules, with one module being provided for the application-specific configuration of the software and containing significant parameters for the current application or for an intended application, and the other module being provided for the analysis of the images which are supplied from the at least one camera, during which analysis the quality of the images is assessed with respect to said parameters.

17. The method as claimed in claim 16, characterized in that said parameters are formed by at least one variable from the group comprising the number of edges in the image, the contrast in the image as an entity, the number of light or dark saturated pixels, and the color of the images, in that the quality of the parameters which characterize the respective image is assessed, and in that the result of this assessment is displayed.

18. The method as claimed in claim 17, characterized in that the result of the assessment of each parameter is displayed by means of a display band which runs in a bar, with the filling level of the bar representing a measure of the quality of the respective parameter.

19. The method as claimed in claim 18, characterized in that the display by means of the display band represents a mean value over a specific number of images.

20. The method as claimed in claim 19, characterized in that, in addition to the mean value of the respective parameter, a value for the current image is also displayed in each bar.

21. An analysis tool for checking the images which are supplied from a camera of a video monitoring device for the functional suitability of the video monitoring device, characterized by a configuration module, which is operable to provide application-specific configuration of the analysis tool, and by a diagnosis module, which is operable to provide the analysis of the images which are supplied from the at least one camera, with the configuration module containing parameters which are significant for functional suitability, and with an assessment of the quality of the images with respect to said parameters being carried out in the diagnosis module.

22. The analysis tool as claimed in claim 21, characterized in that the two modules form part of a program which is stored in a data storage medium.

23. The analysis tool as claimed in claim 22, characterized in that a driver for a frame grabber card and an interface between the frame grabber and the software which is formed by the two modules are additionally stored in the data storage medium.

24. A measurement device for carrying out the method as claimed in claim 15, characterized by a laptop or by some other transportable computer with a keyboard for entering application-specific data, with a screen and with a processor in which the said analysis tool is implemented.

25. The measurement device as claimed in claim 24, characterized in that, in the ready to receive operating mode, a dialog box is displayed on the screen, said dialog box having an image field with the image to be evaluated, a display field for the result of the check, an information field for information about the mode and/or status of the current program, and a row of operating buttons.

26. The measurement device as claimed in claim 25, characterized in that, for the result of the check, the display field has a row of display bars for the individual parameters.

27. The measurement device as claimed in claim 26, characterized in that the image field optionally displays the current image from the at least one camera or an image, which is stored on the hard disk of the laptop, from a previously recorded image sequence.

28. The measurement device as claimed in claim 2, characterized by a frame grabber for temporary storage of the images recorded by the at least one camera.

29. The measurement device as claimed in claim 25, characterized in that the image field optionally displays the current image from the at least one camera or an image, which is stored on the hard disk of the laptop, from a previously recorded image sequence.
